(19) United States
(12) Patent Application Publication
(10) Pub. No.: US 2011/0035140 A1
(43) Pub. Date: Feb. 10, 2011

(54) Vehicle sensing system utilizing smart pavement markers

(76) Inventor: James Candy, Santa Barbara, CA (US)

Correspondence Address: MARK RODGERS, 1590 SAN ROQUE ROAD, SANTA BARBARA, CA, 93105, US

(21) Appl. No.: 12/806,148

(22) Filed: Aug. 5, 2010

Related U.S. Application Data
(60) Provisional application No. 61/273,733, filed on Aug. 7, 2009.

(51) Int. Cl. G08G 1/052; G08G 1/04; E01F 9/08

(52) U.S. Cl. 701/119; 404/12

(57) ABSTRACT

A roadway system is described, consisting of enhance, smart pavement markers. These smart pavement markers contain elements such as motion sensors, solar cells, radio receiver/transmitters, active lighting and processing capability. These markers can be configured in many ways, including as vehicle speed sensors, and information display systems. Such pavement marker systems can be installed with little or no roadway infrastructure preparation and may be useful for traffic data collection, law enforcement, and vehicle safety applications.

### RELATED APPLICATIONS

This application claims priority to U.S. Provisional Application Ser. No. 61/273,733, filed Aug. 7, 2009

### FEDERALLY SPONSORED RESEARCH

Not Applicable

### SEQUENCE LISTING

Not Applicable

### BACKGROUND OF THE INVENTION

This invention is related to pavement markers, and specifically to pavement markers with sensors, standalone power sources and radio communication capability, allowing for vehicle sensing and information display systems to be inexpensively implemented with little or no infrastructure preparation.

Roadway pavement markers are used ubiquitously for light reflective indications of lane and roadway arrangement. These markers can be fixed to roadways, by a simple operation of applying adhesive and placing the marker where desired, basically requiring no road infrastructure preparation, such as trenching or re-surfacing. Once in place, pavement markers are basically maintenance free, and provide no obstacle to wheeled or pedestrian traffic, are immune to weather and can withstand most vehicle loads.

Standard pavement markers are of a size that can provide a lot of interior space for electronic components. Specifically, modern communication systems, processors and sensors and indicators are easily compatible with pavement marker packaging. Thus actively lit pavement markers, as opposed to purely reflective, have become common as crosswalk indicators. Because pavement markers are so easy to install, and so rugged and maintenance free once placed in position, they provide the possibility of being used as building blocks for roadway systems that could significantly aid in vehicle safety, conformance with laws and roadway rules, and traffic management applications. It is the object of this invention to provide roadway sensing and display systems based on enhanced, smart pavement markers.

### BRIEF SUMMARY OF THE INVENTION

In one embodiment, the invention is a vehicle speed sensing system including at least one sensor unit housed in a pavement marker body, or other suitable package. The smart pavement marker includes a pavement marker body, a solar cell and battery charging circuit, a radio unit, a battery, at least one component of a motion detector, and a control unit. The pavement marker is arranged adjacent to vehicle traffic on a road, and is adapted, to sense the passage of a vehicle and thereby calculate the vehicle speed and transmit information related to the vehicle speed by radio. The system may also include at least one component disposed to receive the vehicle speed information and to transmit speed information or take action in response to the speed information.

Various versions of the motion sensing are envisioned. The emitter and receiver may be optical and optical motion detection is accomplished using two pairs of markers, one in each pair having an emitter and the other a receiver, and the pairs are arranged across the vehicle traffic pathway at a known separation, to provide a speed gate. In another version, the emitter and receiver are integrated into a single unit, so only two markers are needed instead of four.

In a preferred embodiment, the speed information is transmitted if the vehicle is exceeding the speed limit. In this embodiment a preferred version of the vehicle speed information component is a plurality of a second type of smart pavement marker, comprising a pavement marker body, a solar cell and battery charging circuit, a radio unit, a battery, a visible light source, and a control unit, wherein the second markers are arranged farther down the vehicle path from the first set, in the field of view of a driver, and in response to radio communication from the first set, provide a visual alert to the vehicle of excessive speed. Other motion sensing devices are contemplated. Such devices may include, but are not limited to:

1. A magnetic device

2. An RF UWB (Ultra-Wide-Band) motion detector

3. An acoustic device

4. An RF ranging device

5. A load sensing device

In another embodiment, the invention is a method for monitoring and reporting traffic flow at a plurality of locations, including the steps of installing solar powered, intelligent, wireless-communications-enabled vehicle speed sensing systems at each monitored location, computing and updating a parameter of traffic flow based on monitored vehicle speed at each location and, accessing the parameter through the wireless communications link. In a preferred version the parameter is average vehicle speed. The vehicle speed parameters from the plurality of locations may be accessed by at least one of individuals, a data center, or, individuals through the data center.

### BRIEF DESCRIPTION OF THE DRAWINGS

The invention will be better understood by referring to the following figures.

FIG. 1 depicts the various versions of pavement markers which can be used as system components.

FIG. 2 depicts the sensor and indicator units of the preferred embodiment.

FIG. 3 depicts a 4-marker speed gate and associated indicator markers.

FIG. 4 depicts a 2-marker speed gate and associated indicator markers.

FIG. 5 depicts a 1-marker speed gate and associated indicator markers

FIG. 6 depicts a marker speed gate transmitting information to a non-marker indicator component.

FIG. 7 depicts an implementation of the system for traffic monitoring by a data center or individuals.

### DETAILED DESCRIPTION OF THE INVENTION

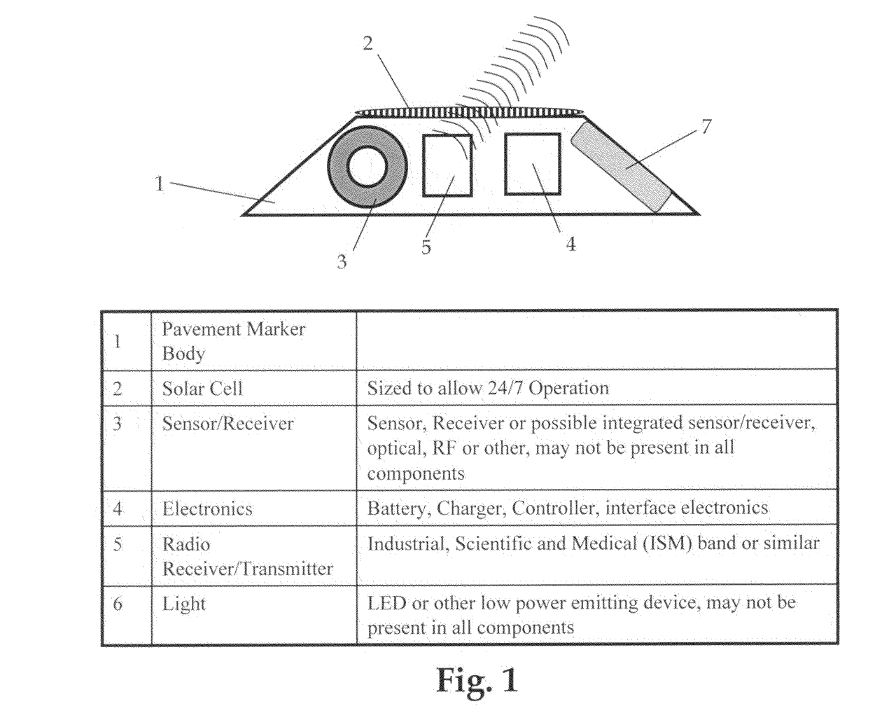

Several possible variants of the pavement marker are contemplated. As shown in FIG. 1, pavement marker 1 may contain a variety of components. In all preferred embodiments, a solar cell 2 is present. The solar cell is the main element that allows the pavement markers to be placed on the surface of roadways, with no wiring or trenching required. Existing solar cells, such as those used in walkway lights have adequate power and are of an appropriate size to work for all intended applications of the invention. Appropriate solar cells of the size and rating for the invention are known in the art. The solar cell is connected to a battery charger and battery 4 of types known in the art, which powers the marker. Most versions of the marker will have a programmable controller as well, of a type known in the art.

The second main element present in all preferred embodiments is radio receiver/transmitter 5. The combination of the radio and solar cell complete the requirement that the markers will need no infrastructure to operate. They are self powered and can communicate wirelessly. Preferably the radio is of a type to support a mesh network standard such as Zigbee, a standard that supports low-power operation as required by the invention. Equally viable is a proprietary mesh networking RF solution operating in the Industrial, Scientific and Medical (ISM) bands or similar. Thus any system composed of such markers may communicate with each other and the outside world readily and using known protocol.

Both sensing and information display functions can be supported by the marker system. Most versions will display by turning on a light, 6, preferably one or more LED's, possibly of multiple colors, or other low power sources. Information can be displayed in most versions by flashing, color, or sequencing multiple display markers in on and off in patterns.

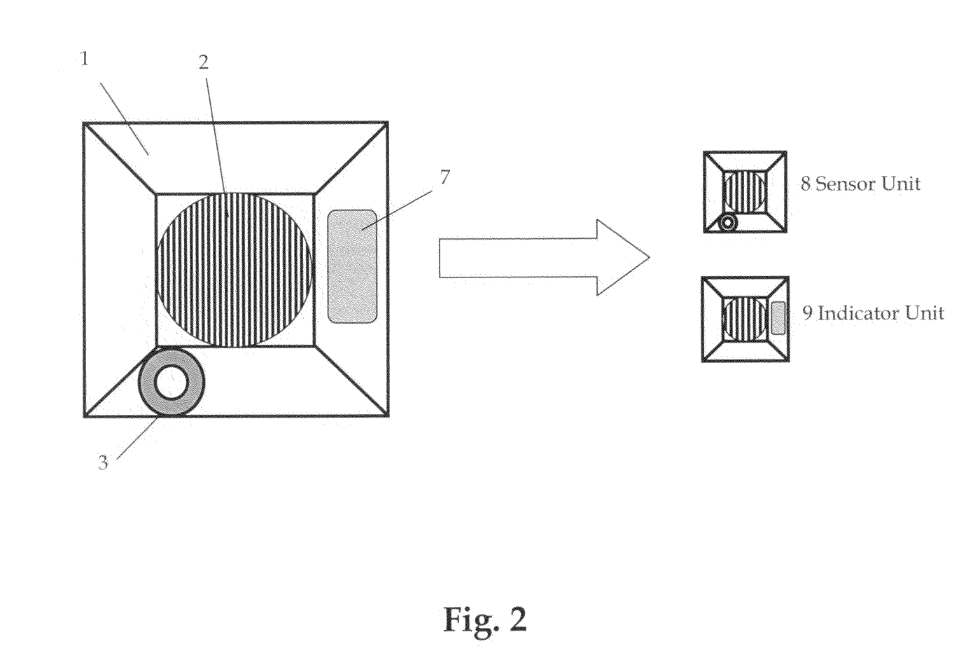

Other versions of the marker will have sensor/receiver elements 3 intended to detect passage of vehicles by installed markers. A variety of arrangements are possible. Markers with either an optical transmitter or receiver are contemplated. For this version, FIG. 2, two markers arranged on opposite sides of a roadway would be required to sense a vehicle passing, and two sets arranged as a speed gate could be employed, using the time difference between the leading edge of an object passing each gate. Alternatively, an integrated optical receiver/transmitter may be used, needing only one marker to sense a vehicle passing, thereby requiring only two markers separated by a known distance. An RF ranging sensor is also contemplated

Referring to FIGS. 2-5 an exemplary roadway system is described. This system uses two types of smart marker, a sensor unit 8 and a display or indicator unit 9.

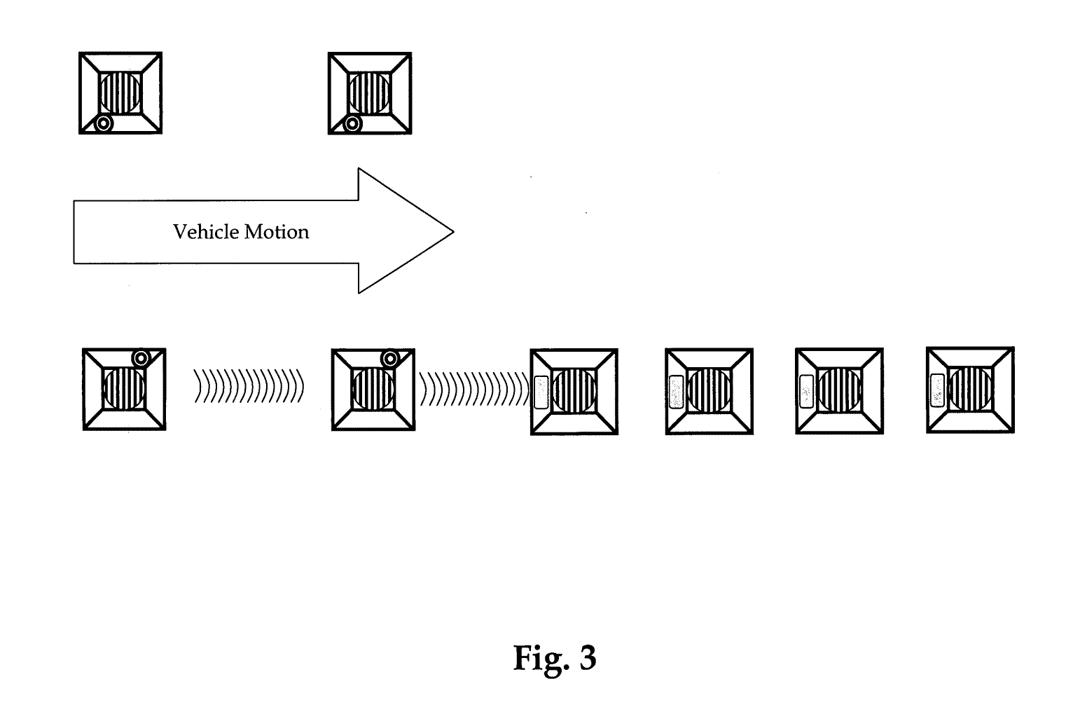

FIG. 3 depicts the exemplary system using markers which have either an optical transmitter or receiver. Two pairs of receiver/transmitter markers are arranged across a roadway lane at a fixed separation. Transmitter markers emit, preferably at a known frequency or pattern, allowing for signal detection by the receiver marker even for very low power emission. When a vehicle interrupts the signal by passing through the first pair, the second pair is informed by radio to start a timer. Thus when the vehicle passes the second pair, the vehicle speed may be calculated. Preferably the leading edge of detection would trigger the timer, but one skilled in the art would see a variety of ways to ensure the timers are started and stopped in a consistent manner. If the speed is excessive, a signal may be transmitted to one or more indicator markers arranged farther down the lane. These indicator markers may flash a pattern and/or color scheme alerting the driver that he is going too fast. The timer preferably times out after an intervals sufficient to capture vehicle traffic, thereby eliminating response to other sensed objects, such as pedestrians.

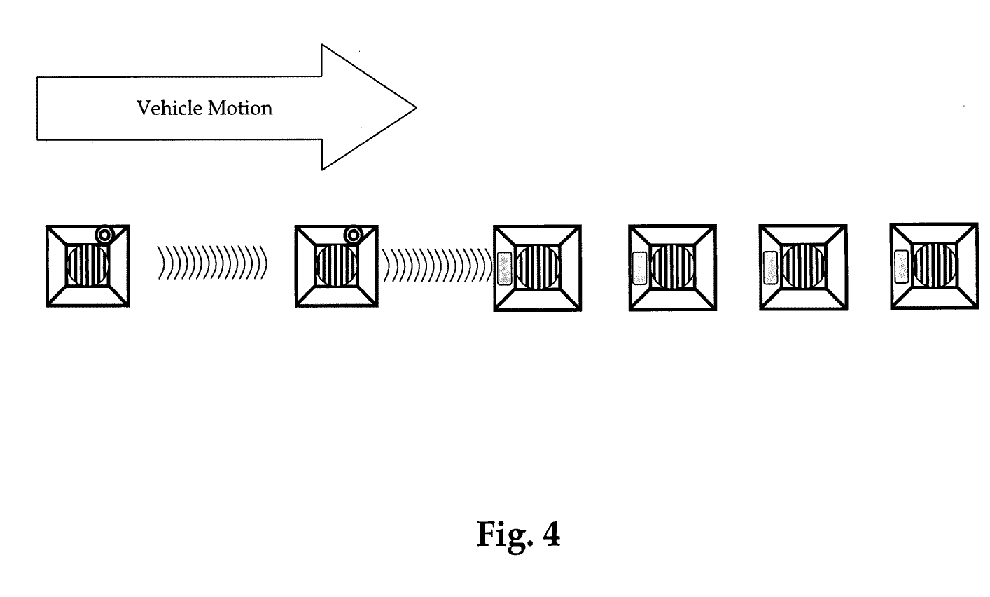

FIG. 4 depicts a similar arrangement for a marker with an integrated transmitter/receiver, thereby requiring only two markers separated by a known distance. Such integrated optical receiver transmitters for detecting a nearby object are known.

Other motion detecting devices are contemplated by the invention. For instance, a piezoelectric wire or strip could extend from the marker across a portion of the roadway, under a coat of somewhat flexible adhesive, such as asphalt. Thus when an object crosses the strip, the deformation of the piezo would generate a signal that could be transmitted to a second similar marker and piezo, thereby achieving an equivalent operation to the optical case. A load sensing device such as described could be tuned to ignore lighter objects such as pedestrians. Other devices which detect motion, such as magnetic or Ultra-Wideband RF devices could be employed,

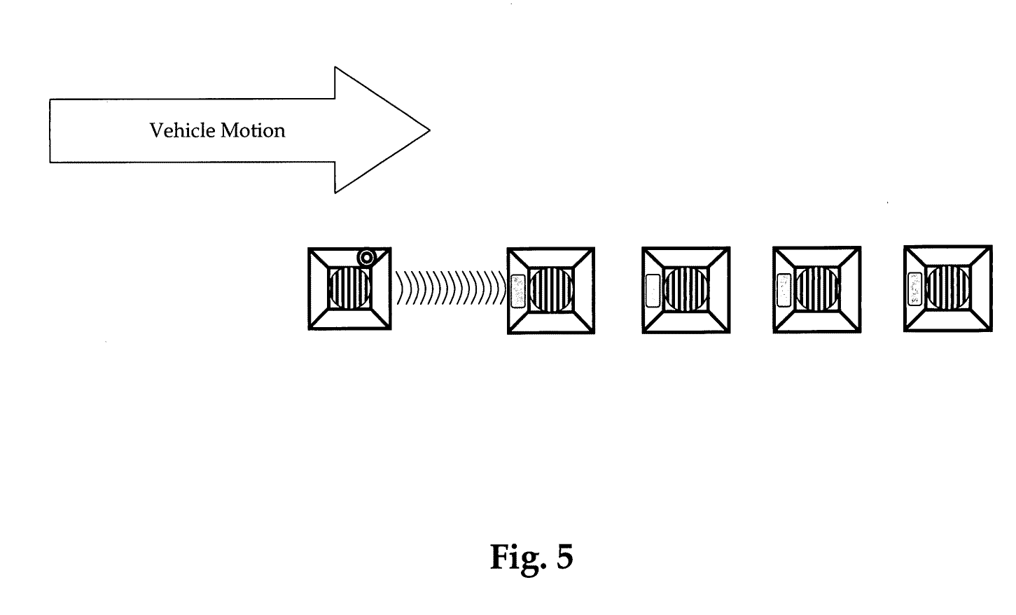

Other motion detecting device may be capable of ranging, thereby only requiring one pavement marker to measure speed as shown in FIG. 5. Micro-power radar devices of the type used in radar guns employed by law enforcement are becoming smaller and lower power, to the point where runners can carry battery powered units to measure their speed against an object. Acoustic sensors, either for detecting airborne sound or ground vibration may be employed for ranging using Doppler analysis or signature analysis. In the case of ranging sensors, only objects traveling at sufficient rate of speed, and producing a sufficient signal strength, need be considered, thereby reducing false readings from smaller, slow speed objects.

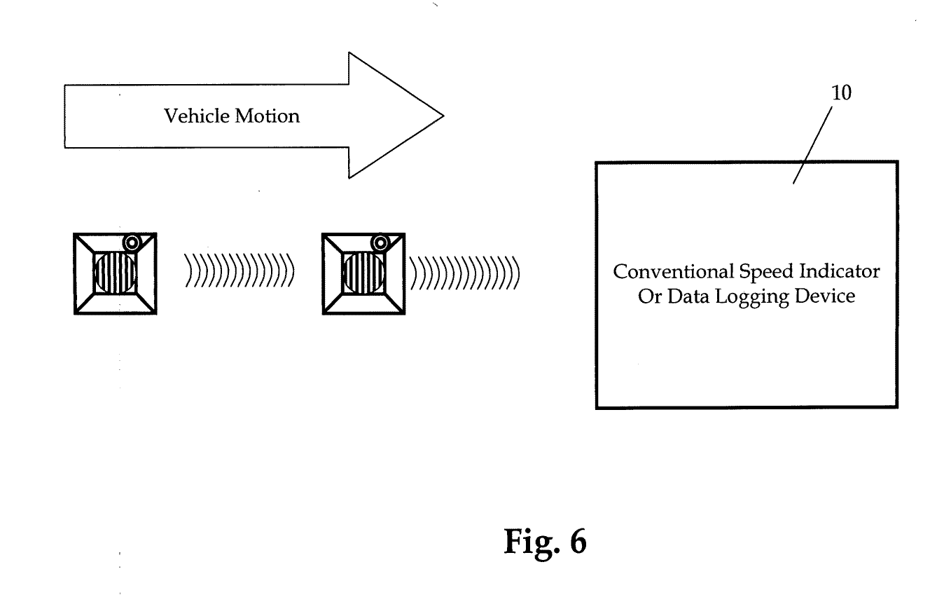

In all versions, the markers are standalone and require only simple placement and programming. Thus a very useful system can be installed quick and inexpensively, almost in any possible roadway location. Alternatively, as shown in FIG. 6, the marker speed measurement system may transmit vehicle speed data to conventional data logging or other devices such as cameras.

The pavement marker embodiments described herein are desirable because their adoption is convenient and inexpensive. Particularly for the case where the system is used as a speed warning device, possible interruptions in service, due to occurrences such as the markers are buried in snow or mud during adverse weather, are tolerable. However the basic components of the system, particularly for embodiments requiring one-sided operation, can be packaged in a variety of configurations other than pavement markers and placed on road dividers, roadside fences, snow poles and the like, to get them up off the road and decrease the amount of down time due to obstruction of the solar cell. One skilled in the art will see a variety of configurations where such units could be mounted to provide for solar charging while maintaining speed sensing. Particularly for the non-optical sensing embodiments, actual placement of the units is flexible.

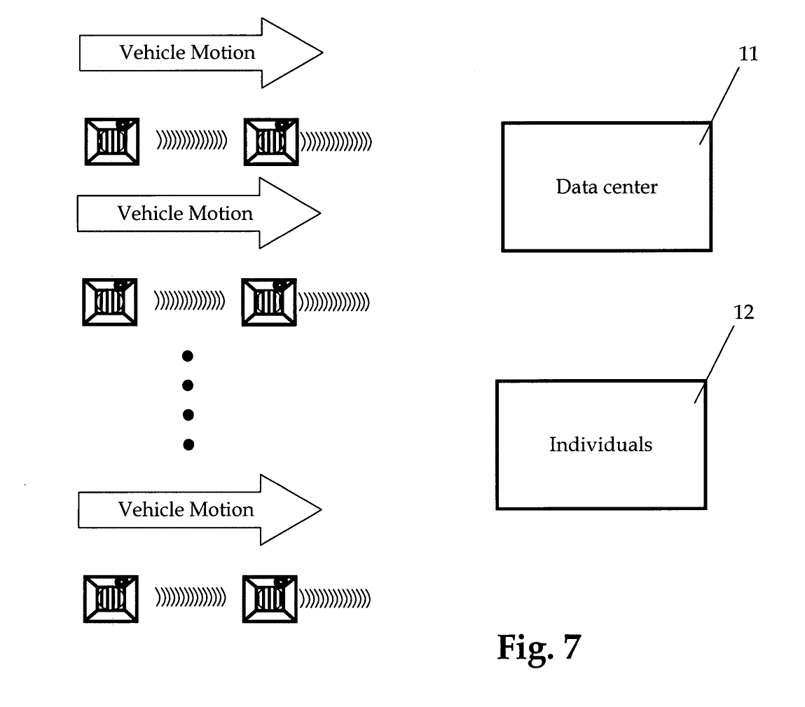

Because the novel speed sensing system is so inexpensive to adopt, one particularly useful implementation is to use the system as one of the inputs to a traffic management or traffic reporting services. For example, individual installations of the system could be programmed to compute average speed of passing vehicles, and transmit the data along with their location either directly or through repeaters, such as cell repeaters, to a data center. Such a center could be accessed by individuals through their phones or PDA's to get up-to-date traffic flow information, and/or used by agencies to monitor and direct traffic in response to up-to-date information. Such systems exist currently, but the inexpensive, convenient installation of the novel systems could greatly increase the number of monitored locations within a given area. With suitable wireless connectivity, users conceivably could access individual installations directly, such as through a cell service, and get traffic flow information for a given location. This implementation is depicted in FIG. 7 where a plurality of speed monitoring system installations transmit either to a center 11, individuals 12, or individuals through the center.

I claim:

1. A vehicle speed sensing system comprising;
at least one smart pavement marker sensor unit, comprising a pavement marker body, a solar cell, a radio unit, a battery, battery charging circuit, and at least one component of a motion sensor, and a control unit; wherein,
the pavement marker is arranged adjacent to vehicle traffic on a road, and is adapted, to sense the passage of a vehicle and thereby calculate the vehicle speed and transmit information related to the vehicle speed by radio; and,
at least one component disposed to receive the vehicle speed information and take action in response to the speed information.

2. The system of claim 1 wherein the motion sensor comprises an optical emitter and receiver.

3. The system of claim 2 wherein the emitter and receiver are integrated into a single unit

4. The system of claim 2 wherein the optical motion detection is accomplished using a pair of markers, one having an emitter and the other a receiver, and the pairs are arranged across the vehicle traffic pathway.

5. The system of claim 1 wherein the speed information is transmitted if the vehicle is exceeding the speed limit.

6. The system of claim 5 wherein the vehicle speed information component comprises a plurality of a second type of smart pavement marker, comprising a pavement marker body, a solar cell, a radio unit, a battery and charger, a visible light source, and a control unit, wherein the second markers are arranged farther down the vehicle path from the first set, in the field of view of the driver, and in response to radio communication from the first set, provide a visual alert to the vehicle of excessive speed.

7. The system of claim 1 wherein the motion detector is an RF ranging device.

8. The system of claim 1 wherein the motion detector is an RF UWB device.

9. The system of claim 1 wherein the motion detector is an acoustic device.

10. The system of claim 1 wherein the motion detector is a magnetic device.

11. The system of claim 1 wherein the motion detector is a load sensing device.

12. A vehicle speed sensing system comprising;
at least one smart sensor unit, comprising a solar cell, a radio unit, a battery and charger, at least one component of a motion sensor, and a control unit; wherein,
the sensor unit is arranged adjacent to vehicle traffic on a road, and is adapted, to sense the passage of a vehicle to thereby calculate the vehicle speed and transmit information related to the vehicle speed by radio; and
at least one component disposed to receive the vehicle speed information and take action in response to the speed information.

13. The system of claim 12 wherein the motion detector is an RF ranging device.

14. The system of claim 12 wherein the motion detector is an RF UWB device.

15. The system of claim 12 wherein the motion detector an acoustic device.

16. The system of claim 12 wherein the motion detector is a magnetic device.

17. The system of claim 13 wherein the motion detector is a load sensing device.

18. The system of claim 13 wherein the motion detector is an optical device.

19. A method for monitoring and reporting traffic flow at a plurality of locations, comprising;
installing solar powered, intelligent, wireless-communications-enabled vehicle speed sensing systems at each monitored location,
computing and updating a parameter of traffic flow based on monitored vehicle speed at each location and,
accessing the parameter through the wireless communications link.

20. The method of claim 19 wherein the parameter is average vehicle speed.
